(19) United States
(12) Patent Application Publication
(10) Pub. No.: US 2006/0265811 A1
(43) Pub. Date: Nov. 30, 2006

(54) Combination crimping tool

(76) Inventor: Beam-Chi Jee, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/135,501

(22) Filed: May 24, 2005

(51) Int. Cl. B25B 7/22

(52) U.S. Cl. 7/128

(57) ABSTRACT

A combination crimping tool is disclosed to have a stopper plate transversely movably mounted in one end of a striker member to stop the stem in the striker member, for enabling the stem to pass to the outside of the striker member after the striker plate has been moved to the rear end of a rear end cap at the rear side of a cylindrical casing to have a tapered inside surface of the rear end cap to move the stopper plate into axial alignment with the striker member so that the striker member can be pushed forwards in a rush to strike the head of the stem and to further drive a push rod and a crimper head to work.

### BACKGROUND OF THE INVENTION

1. Field of the Invention

The present invention relates to a hand tool and more particularly, to a combination crimping tool for crimping and cutting electric wires.

2. Description of the Related Art

A conventional crimping tool for crimping and cutting electric wires is known comprising a striker member, two semicircular stopper members supported on a respective spring member in the rear side of the striker member. When the striker member is moved to the rear side of the outer cylindrical casing, the semicircular stopper members forced by a taper-end rod to move apart, thereby opening the passage for a stem to pass out of the striker member so that the striker member is forced by a spring to strike the head of the stem, achieving the expected crimping and cutting action.

This design of crimping tool is still not satisfactory in function because of the following drawbacks:

1. The spring members that support the semicircular stopper members may be forced out of place easily during working of the crimping tool because the crimping tool has no positioning means to secure the spring members positively in place.

2. Because the rear end cap is fastened to the cylindrical casing of the crimping tool through a screw joint, the threads of the screw joint wear quickly with use due to severe vibration upon each crimping action of the crimping tool.

3. The screw joint complicates the manufacturing cost of the crimping tool.

4. The semicircular stopper members has no guide means to guide in the taper-end rod, and a high push force is required to have the taper-end rod move the semicircular stopper members apart.

### SUMMARY OF THE INVENTION

The invention has been accomplished under the circumstances in view. According to the present invention, the combination crimping tool comprises a tubular casing, the tubular casing having a front end and a rear end; a rear end cap fastened to the rear end of the tubular casing; a main spring mounted inside the tubular casing; a front end cap fastened to the front end of the tubular casing; a cylindrical striker mounted inside the tubular casing and supported on the main spring, the cylindrical striker having a stepped center through hole; a stem mounted in the stepped center through hole of the cylindrical striker, the stem having a head at one end; a thrust spring sleeved onto the stem and stopped between a part inside the cylindrical striker and the head of the stem; a push rod axially movably inserted through the front end cap and stopped against the head of the stem, the push rod having a longitudinal sliding groove extending along the length thereof; a guide rod transversely fastened to the front end cap and perpendicularly inserted into the longitudinal sliding groove of the push rod to guide movement of the push rod in and out of the tubular casing; and a crimper head connected to one end of the push rod outside the tubular casing and adapted to crimping and cutting a workpiece; wherein the striker has a transverse slot transversely disposed near the rear end thereof, and a rear end hole formed in the rear end thereof in communication with the transverse slot; the rear end cap having a tapered inside surface portion; a small spring is mounted inside the transverse slot of the cylindrical striker; a stopper plate is mounted in the transverse slot of the cylindrical striker and supported on the small spring, the stopper plate having tappered peripheral edge adapted to fit the tapered inside surface portion of the rear end cap, a bearing portion pressed on the small spring, a side notch, and a center through hole; a pin is mounted in the rear end hole of the cylindrical striker and inserted through the side notch of the stopper plate to limit the movement of the stopper plate relative to the cylindrical striker to a predetermined range and to stop the stopper plate from falling out of the transverse slot of the cylindrical striker; and wherein the small spring supports the stopper plate in a first position where the tapered peripheral edge is suspending outside the transverse slot, the center through hole of the stopper plate is deviated from the stepped center through hole of the cylindrical striker, and the stem is stopped against the stopper plate; when the push rod is moved backwards toward the inside of the tubular casing, the stem is forced against the stopper plate to push the cylindrical striker backwards and to further force the tapered peripheral edge of the stopper plate against the tapered inside surface portion of the rear end cap to move the stopper plate transversely from the first position to a second position where the center through hole of the stopper plate is in axial alignment with the stepped center through hole of the cylindrical striker for enabling the stem to pass through the center through hole of the stopper plate so that the cylindrical is pushed outwards to strike the head of the stem, thereby forcing the push rod to drive the crimper head to act against the workpiece attached thereto.

### BRIEF DESCRIPTION OF THE DRAWINGS

FIG. 1 is an elevational view of a combination crimping tool according to the present invention.

FIG. 2 is an exploded view of the combination crimping tool according to the present invention.

FIG. 3 is a sectional assembly view of the combination crimping tool according to the present invention, showing the stopper plate in the first position and the push rod extended out of the tubular casing.

FIG. 4 is a schematic cross sectional view of the present invention, showing the stopper plate in the first position.

FIG. 5 is a sectional view of the present invention, showing the stopper plate in the second position and the push rod received inside the tubular casing.

FIG. 6 is similar to FIG. 4 but showing the stopper plate moved to the second position.

FIG. 7 is a sectional view of the present invention, showing the striking action of the cylindrical striker.

### DETAILED DESCRIPTION OF THE PREFERRED EMBODIMENT

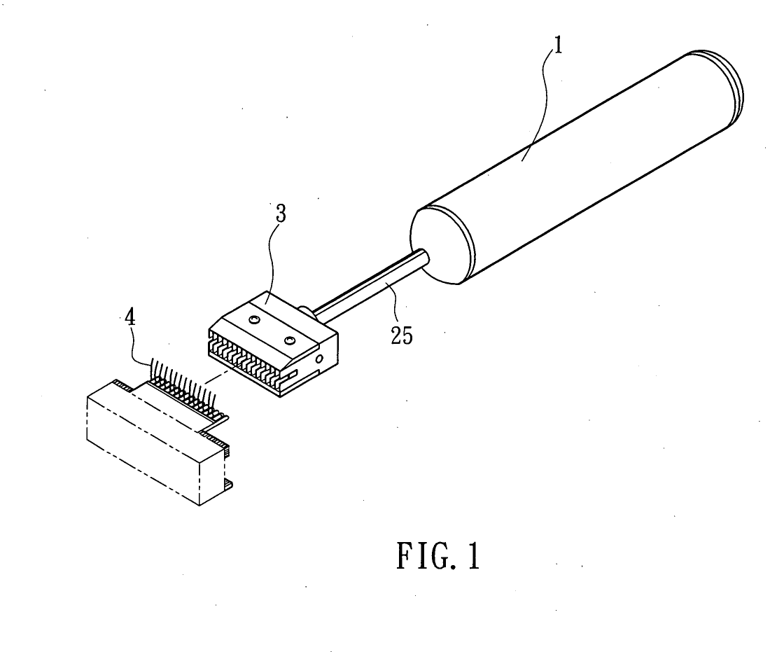

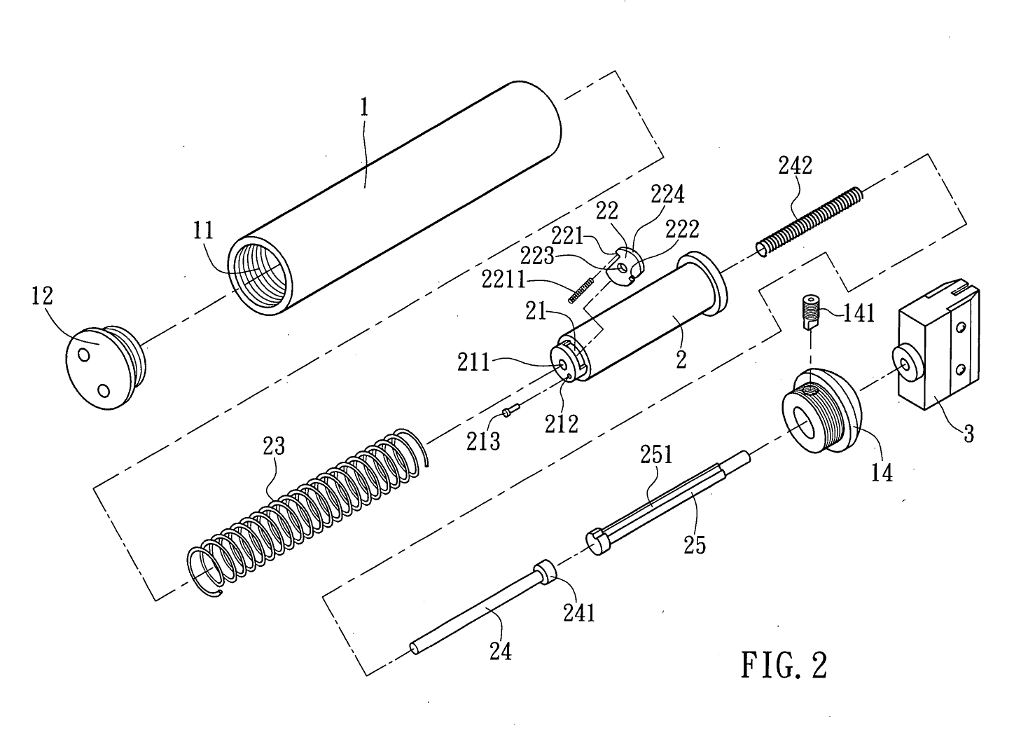

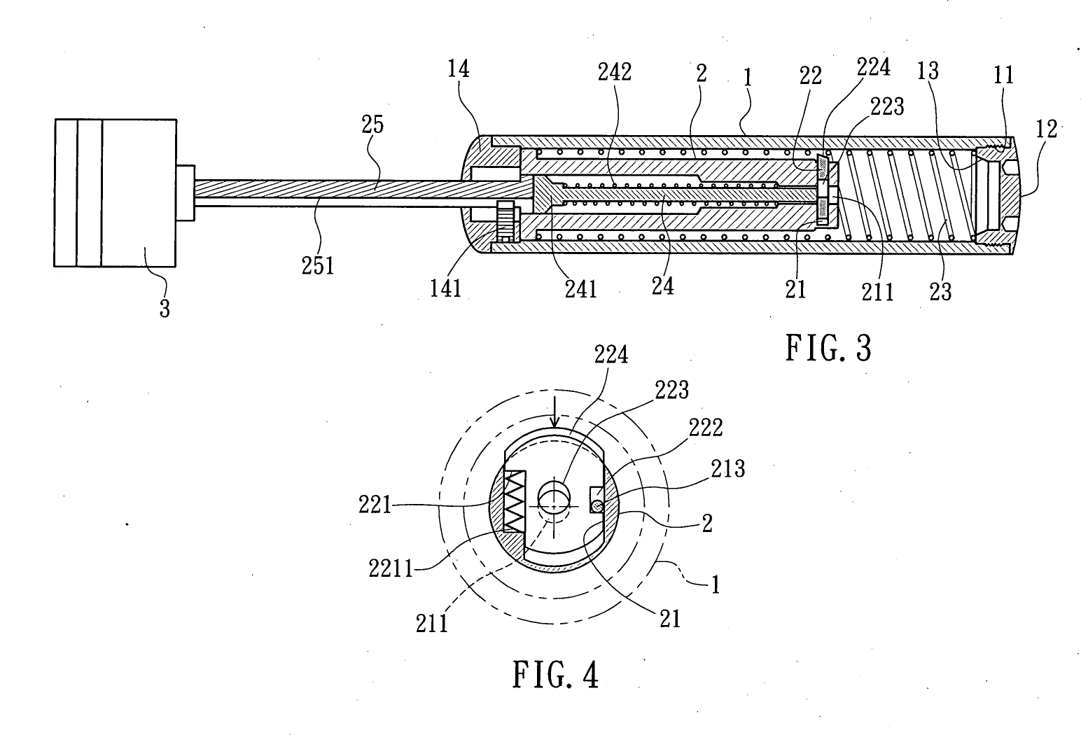

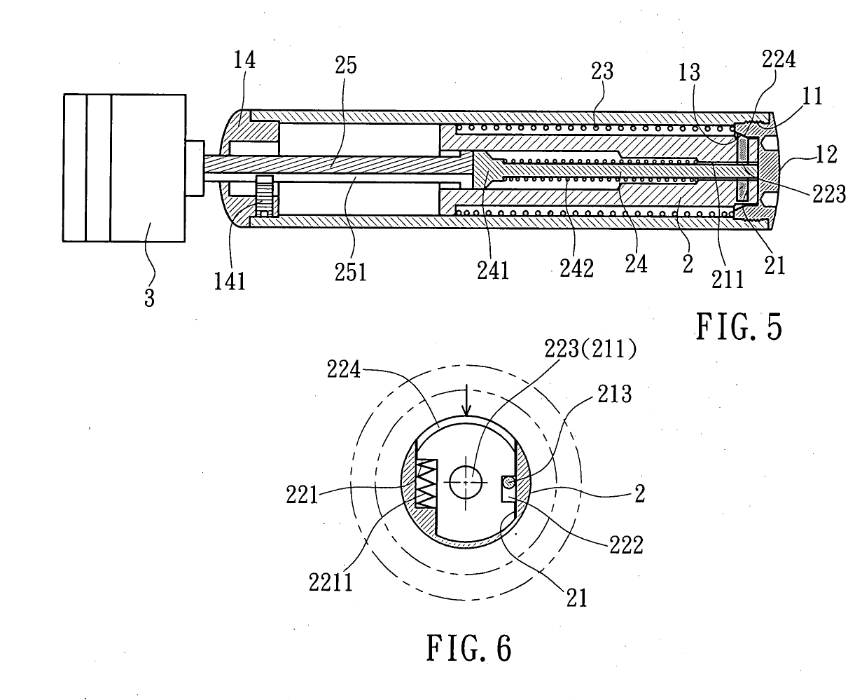

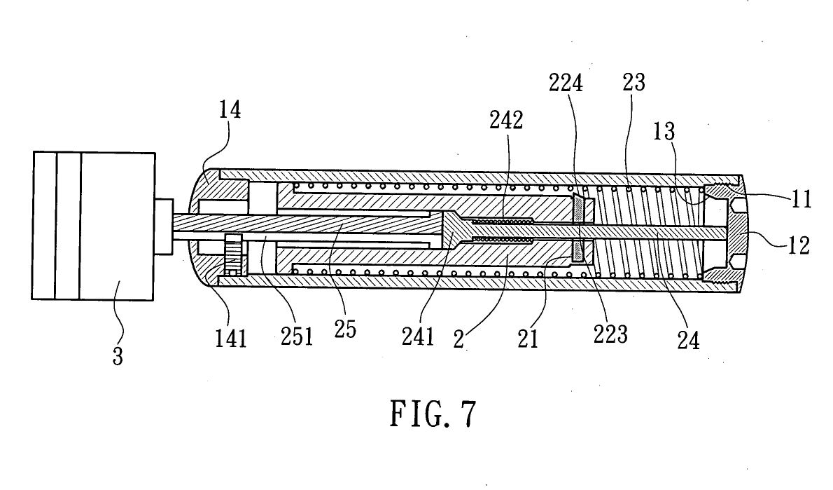

Referring to FIGS. 1˜7, a combination crimping tool is shown comprising:

a tubular casing 1, the tubular casing 1 having an inner thread 11 in the rear end;

a rear end cap 12 threaded into the inner thread 11, the rear end cap 12 having a tapered inside surface portion 13;

a main spring 23 mounted inside the tubular casing 1;

a front end cap 14 fastened to the front end of the tubular casing 1;

a cylindrical striker 2 mounted inside the tubular casing 1 and supported on the main spring 23, the cylindrical striker 2 having a stepped center through hole 211 axially extending through the two distal ends thereof, a transverse slot 21 transversely disposed near the rear end, and a rear end hole 212 formed in the rear end in parallel to the stepped center through hole 211 and in communication with the transverse slot 21;

a stem 24 mounted in the stepped center through hole 211 inside the cylindrical striker 2, the stem 24 having a head 241 at one end;

a thrust spring 242 sleeved onto the stem 24 and stopped between a part inside the cylindrical striker 2 and the head 241 of the stem 24;

a small spring 2211 mounted inside the transverse slot 21 of the cylindrical striker 2;

a stopper plate 22 mounted in the transverse slot 21 of the cylindrical striker 2 and supported on the small spring 2211, the stopper plate 22 having tappered peripheral edge 224 adapted to fit the tapered inside surface portion 13 of the rear end cap 12, a bearing portion 221 pressed on the small spring 2211, a side notch 222, and a center through hole 223;

a pin 213 mounted in the rear end hole 212 of the cylindrical striker 2 and inserted through the side notch 222 to limit the movement of the stopper plate 22 relative to the cylindrical striker 2 to a predetermined range and to stop the stopper plate 22 from falling out of the transverse slot 21 of the cylindrical striker 2;

a push rod 25 axially movably inserted through the front end cap 14 and stopped against the head 241 of the stem 24, the push rod 25 having a longitudinal sliding groove 251 extending along the length;

a guide rod 141 transversely-fastened to the inside of the front end cap and perpendicularly inserted into the longitudinal sliding groove 251 to guide movement of the push rod 25 in and out of the tubular casing 1 and to limit the moving distance of the push rod 25; and

a crimper head 3 connected to one end of the push rod 25 outside the tubular casing 1.

Normally, the small spring 2211 supports the stopper plate 22 in a first position where the tapered peripheral edge 224 is suspending outside the transverse slot 21, the center through hole 223 is deviated from the stepped center through hole 211 of the cylindrical striker 2, and the stem 24 is stopped against the stopper plate 22. When holding the tubular casing 1 with the hand and pushing the push rod 25 backwards toward the inside of the tubular casing 1, the stem 24 is forced against the stopper plate 22 to push the cylindrical striker 2 backwards. Continuously moving the cylindrical striker 2 backwards causes the tapered peripheral edge 224 of the stopper plate 22 to be pressed against the tapered inside surface portion 13 of the rear end cap 12, and therefore the stopper plate 22 is moved transversely from the aforesaid first position to a second position where the center through hole 223 of the stopper plate 22 is in axial alignment with the stepped center through hole 211 of the cylindrical striker 2 for enabling the stem 24 to pass through the center through hole 223 of the stopper plate 22. At this time, the main spring 23 is released from the pressure to return the cylindrical striker 2. During the return stroke, a step inside the stepped center through hole 211 of the cylindrical striker 2 strikes the head 241 of the stem 24, thereby forcing the push rod 25 outwards to drive the internal crimping and cutting mechanism of the crimper head 3 to act against the workpiece 4. After released the pressure from the tubular casing 1, the thrust spring 242 returns the stem 24 and the push rod 25. Immediately after the stem 24 moved over the center through hole 223 of the stopper plate 22, the small spring 2211 pushes the stopper plate 22 from the second position back to the first position to stop the stem 24 inside the cylindrical striker 2 again.

A prototype of combination crimping tool has been constructed with the features of FIGS. 1˜7. The combination crimping tool functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A combination crimping tool comprising:
a tubular casing, said tubular casing having a front end and a rear end;
a rear end cap fastened to the rear end of said tubular casing;
a main spring mounted inside said tubular casing;
a front end cap fastened to the front end of said tubular casing;
a cylindrical striker mounted inside said tubular casing and supported on said main spring, said cylindrical striker having a stepped center through hole;
a stem mounted in the stepped center through hole of said cylindrical striker, said stem having a head at one end;
a thrust spring sleeved onto said stem and stopped between a part inside said cylindrical striker and the head of said stem;
a push rod axially movably inserted through said front end cap and stopped against the head of said stem, said push rod having a longitudinal sliding groove extending along the length thereof;
a guide rod transversely fastened to said front end cap and perpendicularly inserted into the longitudinal sliding groove of said push rod to guide movement of said push rod in and out of said tubular casing; and
a crimper head connected to one end of said push rod outside said tubular casing and adapted to crimping and cutting a workpiece;
wherein:
said striker has a transverse slot transversely disposed near the rear end thereof, and a rear end hole formed in the rear end thereof in communication with said transverse slot;
said rear end cap having a tapered inside surface portion;
a small spring is mounted inside the transverse slot of said cylindrical striker;
a stopper plate is mounted in the transverse slot of said cylindrical striker and supported on said small spring, said stopper plate having tappered peripheral edge adapted to fit the tapered inside surface portion of said rear end cap, a bearing portion pressed on said small spring, a side notch, and a center through hole;
a pin is mounted in the rear end hole of said cylindrical striker and inserted through the side notch of said stopper plate to limit the movement of said stopper plate relative to said cylindrical striker to a predetermined range and to stop said stopper plate from falling out of the transverse slot of said cylindrical striker; and
wherein said small spring supports said stopper plate in a first position where said tapered peripheral edge is suspending outside said transverse slot, the center through hole of said stopper plate is deviated from the stepped center through hole of said cylindrical striker, and said stem is stopped against said stopper plate; when said push rod is moved backwards toward the inside of said tubular casing, the stem is forced against said stopper plate to push said cylindrical striker backwards and to further force said tapered peripheral edge of said stopper plate against the tapered inside surface portion of said rear end cap to move said stopper plate transversely from said first position to a second position where the center through hole of said stopper plate is in axial alignment with the stepped center through hole of said cylindrical striker for enabling said stem to pass through the center through hole of said stopper plate so that said cylindrical is pushed outwards to strike the head of said stem, thereby forcing said push rod to drive said crimper head to act against the workpiece attached thereto.
